(19) United States
(12) Patent Application Publication
(10) Pub. No.: US 2014/0154657 A1
(43) Pub. Date: Jun. 5, 2014

(54) SYSTEM AND METHOD FOR ASSESSING A USER'S ENGAGEMENT WITH DIGITAL RESOURCES

(71) Applicant: CourseSmart LLC, San Mateo, CA (US)

(72) Inventors: Michael David Healy, San Francisco, CA (US); Lorenzo Leon Perez Mellon-Reyes, San Jose, CA (US); Sean Brady, San Mateo, CA (US); Bryan Gentry Spaulding, Burlingame, CA (US); Sean Devine, San Francisco, CA (US)

(21) Appl. No.: 13/914,147

(22) Filed: Jun. 10, 2013

Related U.S. Application Data
(60) Provisional application No. 61/721,592, filed on Nov. 2, 2012.

(51) Int. Cl. G06Q 10/06

(52) U.S. Cl. CPC G06Q 10/0639
USPC 434/362

(57) ABSTRACT

An engagement index reflects a user's level of engagement with a digital resource. Actions of the user, such as the amount of time spent on a page, the number of pages accessed, the amount of time spent in a session, and the number and type of annotations made may be used as factors in the determination of the engagement index. Data values corresponding to one or more of the factors are received and are validated to eliminate any extreme values and to make the values comparable with one another. Different validation methods may be used for different factors. Once the data values are validated, weighting coefficients are applied to the validated values. The system then determines the engagement index by summing the weighted values. Once calculated, the engagement index may be aggregated with other engagement indexes or compared to engagement indexes for other users.

### RELATED APPLICATION

This application claims priority to U.S. Ser. No. 61/721,592 for System and Method for Assessing a User's Engagement with Digital Resources filed Nov. 2, 2012, which is incorporated herein by reference.

### FIELD OF THE INVENTION

The present invention is generally directed to assessing a user's engagement with a digital resource, and more particularly to determining an engagement index.

### BACKGROUND

Educators have used observable behaviors, such as class attendance, class participation, and performance on tests and quizzes, to predict a student's success or failure in a course. Some of these observations may not be made until well into the course, at which point it may be too late to help a student who is not engaged with the course materials and not learning at a pace that will result in successfully completing the course. This may be especially true in higher education where class sizes may be large, classes may be conducted online or via distance learning, and only a few tests or quizzes may be given.

Currently educators do not have a systematic way of assessing student performance until test or quiz results are available. It would be helpful for educators to have a way of assessing the engagement level of students with the course materials in order to identify at-risk students at a point that is early enough to help the students. With the advent of digital course materials, data reflecting a student's interaction with the course materials may be collected and analyzed to assess a student's level of engagement.

### SUMMARY

Aspects of the present invention provide a systematic, timely way of monitoring student behaviors that may be used to measure the engagement of a student with a digital resource. The measured level of engagement may be used by educators to identify at-risk students, by institutions to assess the level of engagement with a particular digital resource or digital resources in general, or by providers of digital resources to assess the level of engagement with a particular digital resource or a portion of the resource.

The monitored student behaviors include interactions or factors, such as the amount of time a student spends on a page, the number of pages accessed by a student, the amount of time a student spends accessing the digital resource in a session, and the number and type of annotations made by the student. The system receives data values corresponding to one or more of these factors and validates the data values. The data values are validated to eliminate any extreme values and to make the values comparable with one another. Different validation methods may be used for different factors. Once the data values are validated, weighting coefficients are applied to the validated values. The system then determines the engagement index by summing the weighted values. Once calculated, the engagement index may be aggregated with other engagement indexes or compared to engagement indexes for other users.

The factors, validation methods, and weighting coefficients may be adjusted as additional data becomes available. In addition, different applications of the engagement index may use different factors, validation method, and/or weighting coefficients.

These illustrative aspects and features are mentioned not to limit or define the invention, but to provide examples to aid understanding of the inventive concepts disclosed in this application. Other aspects, advantages, and features of the present invention will become apparent after review of the entire application.

### BRIEF DESCRIPTION OF THE DRAWINGS

FIG. 1 is a flow diagram illustrating an exemplary method for determining an engagement index.

FIG. 2 is a flow diagram further illustrating the method of FIG. 1.

FIG. 3 is a flow diagram further illustrating the method of FIG. 1.

FIG. 4 is a block diagram illustrating an exemplary operating environment.

FIG. 5 is an exemplary user interface illustrating an exemplary engagement index for all students of an institution.

FIG. 6 is an exemplary user interface comparing an engagement index for a student with the average engagement index for a class.

FIGS. 7A, 7B, and 7C are exemplary user interfaces comparing engagement factors for a student with the average engagement factors for a class.

FIG. 8 is an exemplary user interface showing engagement indexes for students in a class.

### DETAILED DESCRIPTION

One aspect of the invention provides an engagement index that reflects a user's level of engagement with a digital resource. As used herein, a digital resource includes, but is not limited to, electronic books, including electronic textbooks (“eTextbooks”), electronic course materials, and other types of content that may be delivered electronically. The user's interactions with the digital resource are monitored and the data collected is used to calculate the engagement index.

### Data Collection

When a user interacts with a digital resource, there are a number of factors that can be measured, such as the amount of time that the user spends on a page, the number of pages accessed by the user, the amount of time the user spends accessing the digital resource, and the number and type of annotations made by the user. A combination of these or similar factors may be analyzed in order to determine the engagement index.

For purposes of illustration the engagement index will be described in the context of a student accessing an eTextbook. The student accesses the eTextbook via an eTextbook delivery platform. The delivery platform not only provides the student with access to the eTextbook, but also captures the data needed to calculate the engagement index.

The student may “stream” the contents of the eTextbook to a web browser on their laptop, desktop, smartphone, tablet, mobile device, or other type of reading device. In this situation the delivery platform may store a time stamp when the session starts, as well as time stamps when each page is requested, when any annotation is made, and when the session ends. The delivery platform may also collect additional data, such as the number of pages accessed and annotation details, such as words highlighted or notes made.

Alternatively, the student may store a local copy of the eTextbook on their laptop, desktop, smartphone, tablet, mobile device, or other type of reading device. In this situation, time spent engaging with the eTextbook may be derived from the user synchronizing actions taken in an “offline reading” mode with the delivery platform. The synchronization of “offline reading” actions may trigger the collection of data about those actions along with dates and times that those offline actions were taken.

Once the data is collected, there may be some initial processing of the data. The initial processing may depend upon the type of data received, as well as the data needed to determine the engagement index. The initial processing may automatically detect and exclude invalid data. For example, a student's attempt to access a page that does not exist would not be included in the page count.

The specific data collected and the way the values used in the engagement index are determined may vary between systems. If the engagement index uses time spent on a page, then the value may be determined by considering the total number of pages viewed in a session and the session length. In this case, the time spent on a page may be determined by spreading the time evenly across the number of pages accessed during the session or by spreading the time based on a weighting that considers the complexity or level of detail of the information presented on each page. Alternatively, the time spent on a page may be determined using time stamps that capture the time when each page is loaded.

### Engagement Index

The engagement index is calculated at the session level. A session may be a single period during which the student is engaged with the digital resource. In the eTextbook example, the session may include a 2-hour time period during which the student views pages within an eTextbook and makes annotations Annotations include highlights, bookmarks and notes, where the notes may be associated with a particular page or with a particular anchor point on a particular page. The engagement index may consider one or more of the following factors: the number of pages viewed, the length of a session, and the annotations made. Additional factors that may be considered include factors related to path analysis, i.e., the order of the pages viewed, and factors related to the system or device used by the user to access the eTextbook, such as the device type, operating system and version, and/or application features utilized. When a factor is related to viewing, the factor may also include printing or sharing with other users, and when a factor is related to making an annotation, the factor may also include viewing, printing, editing, sharing or deleting an annotation.

Multiple engagement indexes can be analyzed together by considering indexes with one or more common dimensions. A time dimension may consider multiple engagement scores for a week, month, term, or other time period. A user dimension may consider multiple engagement scores for students, faculty members, courses, institutions, or other groups of users. A geographic dimension may consider multiple engagement scores for a city, a county, a state, a region, or other geographic area. A content dimension may consider multiple engagement scores for a page, a section, an ISBN, a discipline, a publisher, or other type of content.

The engagement index may individually weight the factors. For example, if the engagement index is intended to be used to identify at-risk students and it is determined that session length is a better predictor than annotations made, then the session length will be given more weight than the number of annotations.

One exemplary form of an engagement index (EI) is shown below:

$$EI = {f}_{0} ( a * {f}_{1} ( first factor value ) + b * {f}_{2} ( second factor value ) + c * {f}_{3} ( third factor value ) + … + z * fn ( last factor value ) )$$

### Where

a, b, c, . . . z represent weighting coefficients
ƒ_{1, 2, . . . n} represent factor validation functions
ƒ₀ represents an index validation function
   In the context of a student accessing an eTextbook, this equation may be implemented as shown below:

$$EI = {f}_{0} ( a * {f}_{1} ( session page views ) + b * {f}_{2} ( session duration ) + c * {f}_{3} ( session notes made ) + d * {f}_{4} ( highlights made ) + e * {f}_{5} ( bookmarks made ) )$$

The weighting coefficients determine the relative contribution of each factor to the engagement index and are independent of each other. The weighting coefficients may differ based on the subject matter of the digital resource, the specific course, the specific institution providing the course, the type of institution (e.g., private or public) providing the course, the type of course (e.g., traditional, online, distance, or a blend), the instructor, or any other relevant dimension. In one implementation, the weighting coefficients have the following values: a=35%, b=35%, c=10%, d=10%, e=10%. In this implementation, a low engagement index indicates a lack of engagement with the course materials, while a high engagement index indicates significant engagement with the course materials.

One of the purposes of the factor validation functions is to adjust the factor values so they are comparable to one another and do not include any extreme values. Another one of the purposes of validating the factor values is to ensure that the values accurately reflect engagement with the digital resource. If the factor is related to pages viewed, then the validated value should more closely reflect the number of pages where there was meaningful interaction between the user and the page. For example, if a user reads or skims 3 pages, but “flips” through 10 additional pages to navigate to those 3 pages, then the validated value should be closer to 3 than to 13. To implement this factor validation function, the time spent on a page may be compared to a threshold time and the result of the comparison used to determine whether the page is included in the page count or not. In this manner, a page that is flipped to get to the next page, is not included in the validated value.

Another exemplary factor validation function considers the length of the session and attenuates session lengths that exceed a threshold. The threshold is selected based on a length of time that a user would realistically interact with a digital resource. It prevents the digital equivalent of a user leaving a book open for hours, but not reading the book. Yet another exemplary factor validation function limits the factor value to a value between a predetermined upper value and a predetermined lower value.

Another exemplary validation function compares the number of words or lines highlighted to a threshold to determine whether to count the highlight. Yet another exemplary validation converts the number of words in a note to a number of characters and compares the number of characters to a threshold to determine whether to count the note.

Another purpose of validating the factor values is to ensure that the values are consistent with other factor values and fit within the range of the engagement index. In one implementation, the engagement index uses a 100 point scale. In this implementation, the factor validation functions and the weighting coefficients are selected so the sum generally falls within the 100 point scale. For example, a factor validation function for session length converts a session length in seconds to a session length in minutes to better fit within the range of the engagement index. Other types of validation that adjust, transform, and/or convert a factor value to one that more accurately reflects engagement or that is more comparable to other factor values are also included and will be apparent to those skilled in the art.

The index validation function bounds the value of the engagement index to a predetermined range. In one implementation, the index validation function places an upper and a lower bound on the value of the engagement index. Once the factor values are validated and the weighted values are added together, the index validation function adjusts the sum. For example, a lower bound (e.g., 20) may be added to the sum and if the adjusted sum exceeds an upper bound (e.g., 100), then the upper bound may be used as the engagement index.

The method of calculating the engagement index may be adjusted over time or may differ based on its intended use. The adjustments may include the use of different factors, different validation functions, and/or a different weighting of the factors. For example, if the engagement index is to be used to identify at-risk students, then the way the index is calculated may be adjusted based on how well the engagement indexes for students in a previous course correlated with the students' successful completion of the course. If the weighting coefficients for the previous course were set so that the weighting coefficient for the factor related to number of pages viewed was larger than the weighting coefficient for the factor related to highlights made, but highlights made was found to be a better predictor for successfully completing the course, then the weighting coefficients may be adjusted for the engagement index for a subsequent course.

### Method for Determining an Engagement Index

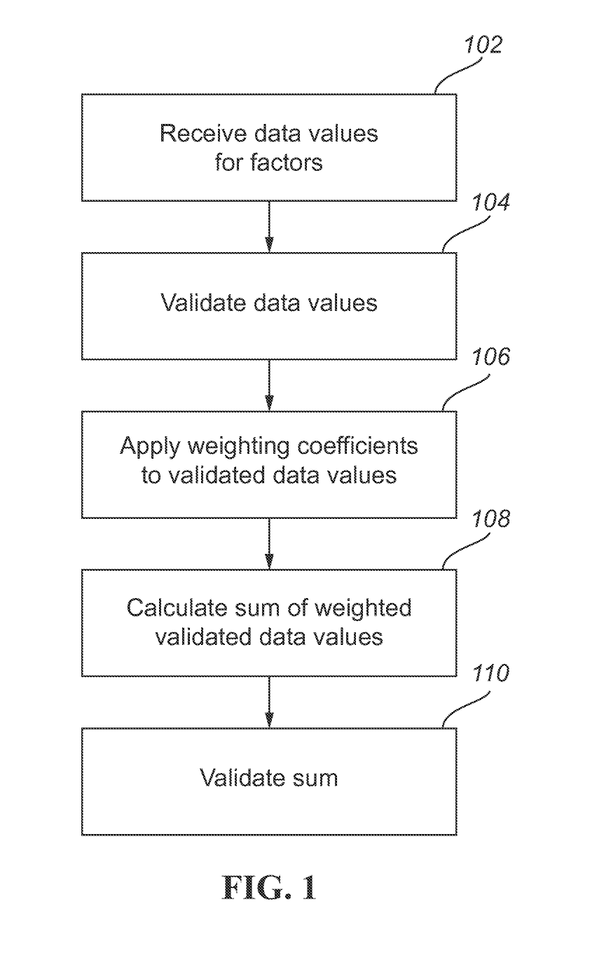

FIG. 1 illustrates an exemplary method for determining an engagement index. The method begins at 102 where the system receives the data values for the factors used in the engagement index. At 104, the system applies a factor validation function to each of the data values. Once the data values are validated, the system applies a weighting coefficient to each of the values at 106. At 108, the system adds the weighted validated data values together and at 110, the system validates the sum using the index validation function.

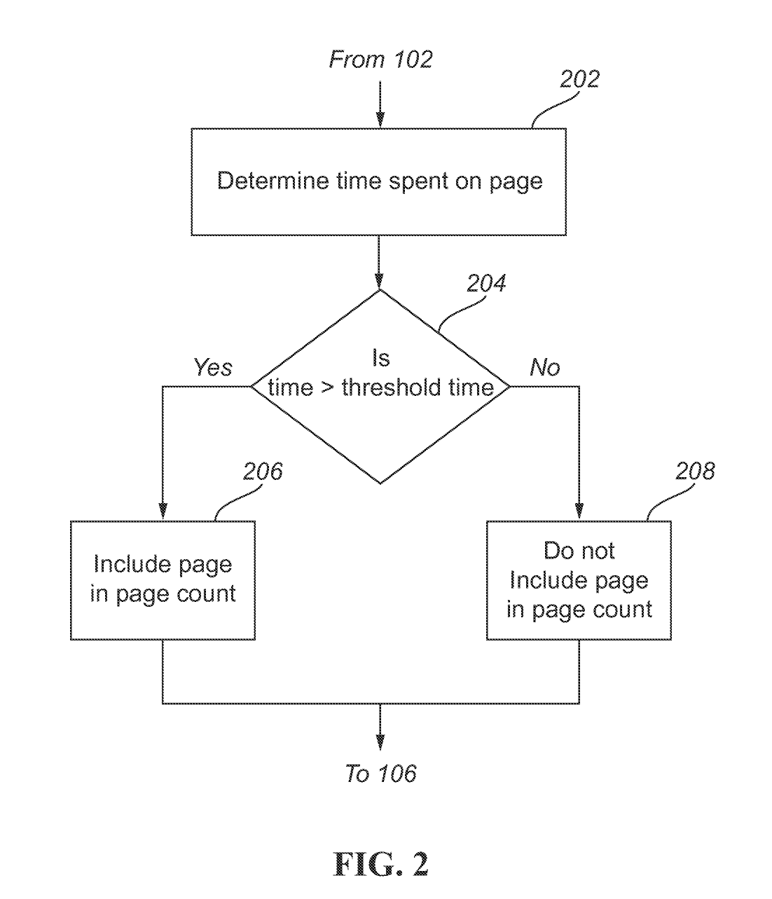

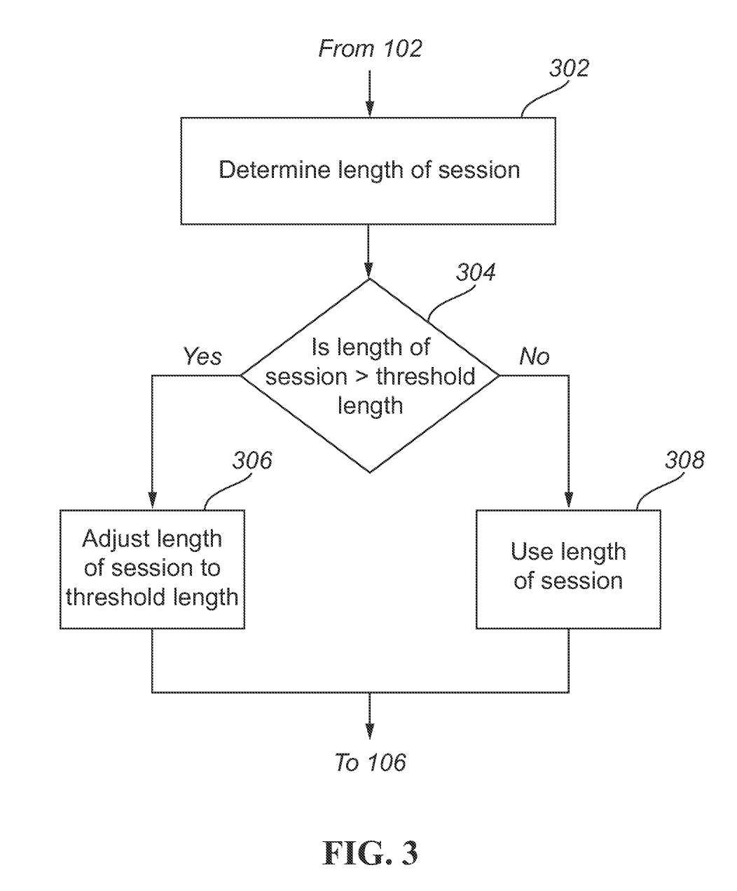

FIGS. 2 and 3 each illustrate the system's application of an exemplary factor validation function also referred to herein as a validation method, as shown at 104 in FIG. 1. FIG. 2 illustrates a factor validation function related to page count. The method proceeds from 102 in FIG. 1 to 202 in FIG. 2 where the system determines the time spent on a page. At 204, the system compares the time spent on the page to a threshold time. If the time spent on the page is greater than the threshold time, then the system follows the Yes branch to 206 and includes the page in the page count. If the time spent on the page is not greater than the threshold time, then the system follows the No branch to 208 and does not include the page in the page count. The system proceeds to 106 in FIG. 1 from either 206 or 208.

FIG. 3 illustrates a factor validation function related to session length. The method proceeds from 102 in FIG. 1 to 302 of FIG. 3 where the system determines the length of the session. At 304, the system compares the length of the session to a threshold length. If the session length is greater than the threshold length, then the system follows the Yes branch to 306 and the system adjusts the session length to equal the threshold length. If the session length is not greater than the threshold time, then the system follows the No branch to 308 and uses the session length to determine the engagement index. The system proceeds to 106 in FIG. 1 from either 306 or 308.

### Exemplary Operating Environment

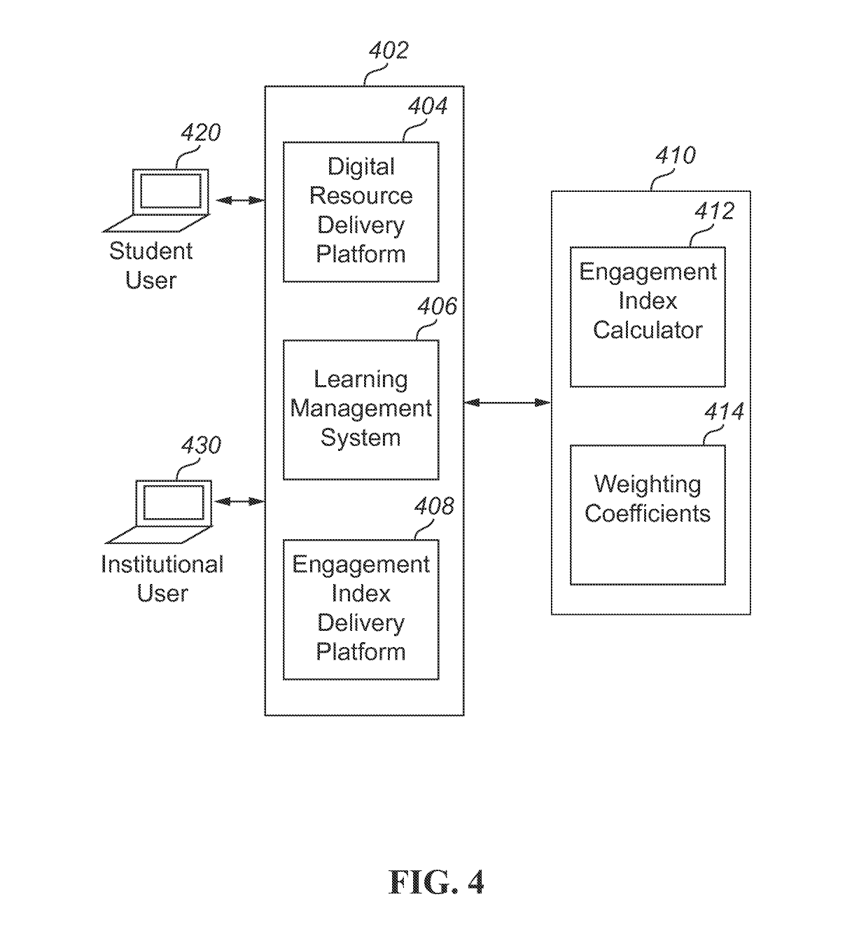

FIG. 4 illustrates an exemplary operating environment for the example of a student accessing an eTextbook. FIG. 4 illustrates a first system 402 that includes a digital resource delivery platform 404, a learning management system (LMS) 406 and an engagement index delivery system 408. The digital resource delivery platform provides a student 420 with access to an eTextbook or other digital resources. The digital resource may be stored on system 402 or may be stored on another system (not shown) that is accessed by system 402. The digital resource delivery system and/or the engagement index delivery platform may be part of the LMS or may be a separate platform. The LMS may integrate the delivery platforms into the institution's work flow and may provide contextual information, such as the user's role, e.g., student or faculty, and the course identifier to the engagement index calculator. The engagement index delivery platform provides a user interface for presenting the engagement index to an institutional user 430, such as an educator or administrator. The engagement index delivery platform may also provide security and authentication functions to restrict access to student data to only authorized users.

FIG. 4 also illustrates a second system 410 for calculating the engagement index that includes an engagement index calculator 412 and the weighting coefficients 414 used to calculate the engagement index. Since the weighting coefficients may differ for different courses or areas of study, there are likely multiple sets of weighting coefficients needed for a single institution. In one exemplary system, the engagement index calculator performs the operations described above in connection with FIGS. 1-3. Although FIG. 4 illustrates two systems, in other implementations the illustrated components may be part of the same system or may be distributed differently.

The systems illustrated in FIG. 4 are not limited to any particular hardware architecture or configuration. The systems may include a computing device, a storage device, interfaces for connecting with other systems, and additional components. A computing device may include any suitable arrangement of components and include multipurpose microprocessor-based computer systems. The computing device may access computer-executable instructions from a computer-readable medium so that when the instructions are executed the computing system is transformed from a general-purpose computing apparatus to a specialized computing apparatus implementing one or more aspects of the present invention. Any suitable programming, scripting, or other type of language or combinations of languages may be used to implement the computer-executable instructions.

### Exemplary User Interface

The engagement index delivery platform provides a user interface that communicates engagement indexes and other information regarding engagement. The engagement indexes may be aggregated across one or more dimensions, where the dimensions include, but are not limited to users, digital resources, courses, time periods, and institutions.

Aggregation of engagement indexes for a specific digital resource may provide useful information for a provider of the digital resource. A low engagement index around a particular page, section, or book may suggest that changes are needed to the content. Aggregation for all digital resources used in a class or course may provide useful information for identifying at-risk students. An engagement index that reflects an average across multiple students may be compared to an individual student's engagement index to assess the engagement of the individual user with respect to other users in the class or course. If the individual student's engagement index is significantly lower than the rest of the class, then the student may be at risk.

FIG. 5 illustrates a user interface that displays an engagement score (89.50) for all students for a particular institution for a particular month. In addition to the engagement score the user interface displays the average session length (42.57 minutes), the average pages viewed (39), the average number of annotations (5.81) and the number of digital resources (30) included in the index. In FIG. 5 the average of the engagement indexes for multiple students for multiple digital resources over a one-month period is presented as the engagement index.

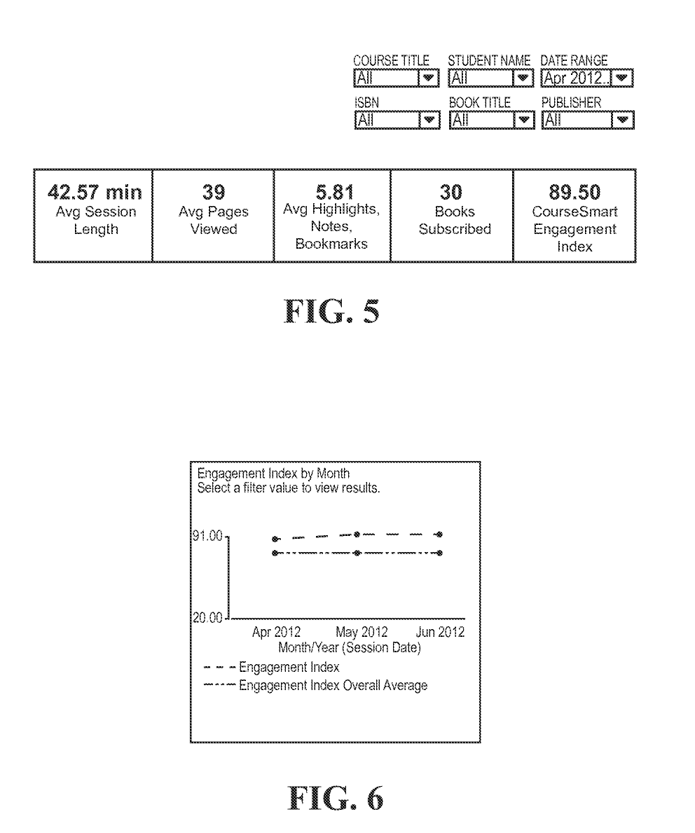

In another example, the system aggregates engagement indexes over time. FIG. 6 compares the average of the engagement indexes for a particular student over a certain time period with the average of the engagement indexes for all of the students in the class or course over the same period of time. The engagement indexes may be related to a single digital resource or may be related to all digital resources for the class.

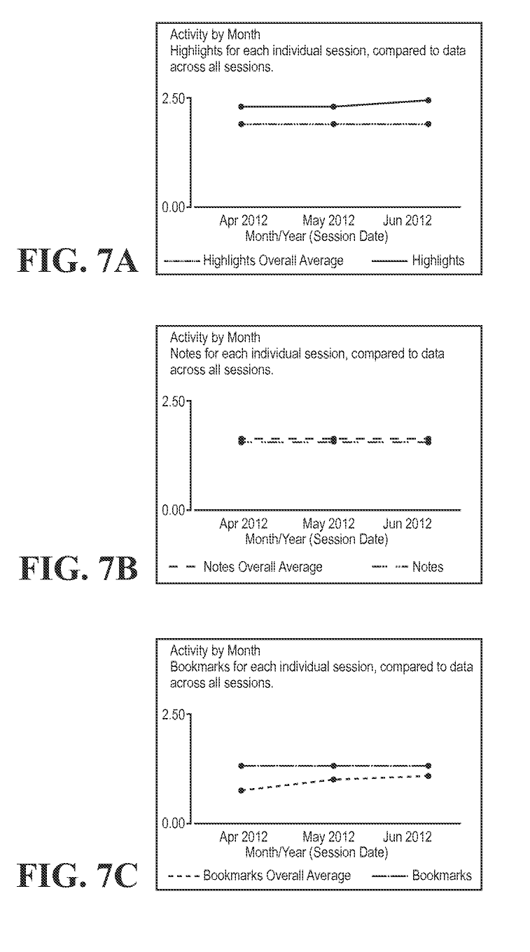

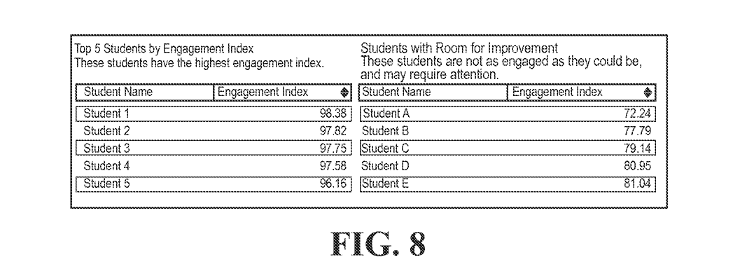

FIGS. 7A, 7B, and 7C illustrate the validated annotation factor values used in the engagement indexes of FIG. 6. The figures compare the average number of annotations for a particular student over a certain time period with the average annotations for all of the students in the class over the same time period. FIG. 7A compares bookmarks, FIG. 7B compares notes, and FIG. 7C compares highlights. Although shown separately, the comparisons could be combined into a single presentation. The values may be related to a single digital resource or may be related to all digital resources for the class. The presentation of this information may help identify the specific activity or activities where the particular student differs from the rest of the class.

While the present subject matter has been described in detail with respect to specific aspects thereof, it will be appreciated that those skilled in the art, upon attaining an understanding of the foregoing, may readily produce alterations to, variations of, and equivalents to such aspects. Although the invention has been described in connection with digital resources that provide text or other types of displayed content, the invention may also be used with other forms of digital content, including video content and content delivered acoustically. Accordingly, it should be understood that the present disclosure has been presented for purposes of example rather than limitation, and does not preclude inclusion of such modifications, variations, and/or additions to the present subject matter as would be readily apparent to one of ordinary skill in the art.

What is claimed is:

1. A method for calculating a measure of engagement with a digital resource, comprising:
monitoring a user's interactions with the digital resource to determine values for a plurality of factors, wherein a first factor corresponds to an amount of content of the digital resource accessed by the user during a session, a second factor corresponds to a length of the session, and a third factor corresponds to an annotation of the digital resource by the user;
validating the values for the factors by: using a first validation method for validating a first value for the first factor, using a second validation method for validating a second value for the second factor, and using a third validation method for validating a third value for the third factor;
applying a first predetermined weighting coefficient to the validated value for the first factor, applying a second predetermined weighting coefficient to the validated value for the second factor, and applying a third predetermined weighting coefficient to the validated value for the third factor; and
determining the measure of engagement for the user based upon the weighted validated values for the factors.

2. The method of claim 1, wherein the third factor indicates a number of one or more of the following: highlights made in the digital resource by the user, bookmarks made in the digital resource by the user, or notes associated with the digital resource by the user.

3. The method of claim 1, wherein determining the measure of engagement, comprises:
calculating a sum of the weighted validated values for the factors; and
adjusting the sum so that the sum is at least as large as a predetermined lower bound and is no larger than a predetermined upper bound.

4. The method of claim 1, further comprising: comparing the measure of engagement for the user to measures of engagement for other users that have accessed the digital resource

5. The method of claim 1, wherein the first value indicates a number of pages and using a first validation method for validating a first value for the first factor comprises counting only pages accessed for at least a threshold amount of time.

6. The method of claim 1, wherein using a second validation method for validating a second value for the second factor comprises: converting the second value from seconds to minutes.

7. The method of claim 1, wherein using a second validation method for validating a second value for the second factor comprises: determining that the second value exceeds a threshold length and replacing the second value with the threshold length.

8. The method of claim 1, further comprising: aggregating the measure of engagement for the user with other measures of engagement for the user to obtain an average measure of engagement for the user over a time period.

9. The method of claim 1, further comprising: aggregating the measure of engagement for the user with measures of engagement for other users for the digital resource to obtain an average measure of engagement for the digital resource.

10. The method of claim 1, wherein monitoring a user's interactions with the digital resource comprises: monitoring the user's interactions with the digital resource via a laptop, desktop, smartphone, tablet, mobile device or reading device.

11. A method for calculating a measure of engagement with a digital resource, comprising:
receiving data values for a plurality of factors that correspond to a user's interactions with the digital resource, wherein a first factor corresponds to a number of pages accessed by the user during a session and a second factor corresponds to a length of the session;
validating a first value for the first factor by counting only pages accessed for at least a threshold amount of time;
validating a second value for the second factor by comparing the length of the session to a threshold length and if the length of the session exceeds the threshold length, then setting the second value to the threshold length;
applying a first predetermined weighting coefficient to the validated value for the first factor;
applying a second predetermined weighting coefficient to the validated value for the second factor; and
determining the measure of engagement for the user based upon a sum of the weighted validated values for the factors.

12. The method of claim 11, further comprising: adjusting the sum so that the sum is at least as large as a predetermined lower bound and is no larger than a predetermined upper bound.

13. The method of claim 11, further comprising: comparing the measure of engagement for the user to measures of engagement for other users that have accessed the digital resource

14. The method of claim 11, further comprising: aggregating the measure of engagement for the user with other measures of engagement for the user to obtain an average measure of engagement for the user over a time period.

15. The method of claim B, further comprising: aggregating the measure of engagement for the user with measures of engagement for other users for the digital resource to obtain an average measure of engagement for the digital resource.

16. A system for calculating a measure of engagement with a digital resource, comprising:
an interface for receiving data values for a plurality of factors that correspond to a user's interactions with the digital resource, wherein a first factor corresponds to an amount of content of the digital resource accessed by the user during a session and a second factor corresponds to a length of the session;
a storage device for storing at least a first predetermined weighting coefficient and a second predetermined weighting coefficient;
a computing device operable to access the interface and the storage device and to execute instructions for:
validating the values for the factors by: using a first validation method for validating a first value for the first factor and using a second validation method for validating a second value for the second factor;
applying the first predetermined weighting coefficient to the validated value for the first factor and applying the second predetermined weighting coefficient to the validated value for the second factor; and
determining the measure of engagement for the user based upon a sum of the weighted validated values for the factors.

17. The system of claim 16, wherein the computing device is further operable to execute instructions for: adjusting the sum so that the sum is at least as large as a predetermined lower bound and is no larger than a predetermined upper bound.

18. The system of claim 16, wherein the computing device is further operable to execute instructions for: comparing the measure of engagement for the user to measures of engagement for other users that have accessed the digital resource and to display the comparison.

19. The system of claim 16, wherein the computing device is further operable to execute instructions for: aggregating the measure of engagement for the user with other measures of engagement for the user to obtain an average measure of engagement for the user over a time period and to display the average measure of engagement for the user.

20. The system of claim 16, wherein the computing device is further operable to execute instructions for: aggregating the measure of engagement for the user with measures of engagement for other users for the digital resource to obtain an average measure of engagement for the digital resource and to display the average measure of engagement for the digital resource.
